(19) United States
(12) Patent Application Publication
(10) Pub. No.: US 2025/0287083 A1
(43) Pub. Date: Sep. 11, 2025

(54) PHOTOGRAPHIC DEVICE

(71) Applicant: Shenzhen Reolink Technology Co., Ltd., Shenzhen (CN)

(72) Inventor: Jun Zhang, Shenzhen (CN)

(21) Appl. No.: 18/985,286

(22) Filed: Dec. 18, 2024

(30) Foreign Application Priority Data
Mar. 11, 2024 (CN) 202420470484.5

(51) Int. Cl. H04N 23/52; H04N 23/51; H04N 23/54; H04N 23/55

(52) U.S. Cl. CPC H04N 23/52; H04N 23/51; H04N 23/54; H04N 23/55

(57) ABSTRACT

A photographic device includes a housing, a mainboard disposed inside the housing, and an imaging module including a photosensitive sensor and a lens assembly. The mainboard is provided with pillars, and a sub-circuit board is connected to one side of the mainboard through the pillars and has a gap with the mainboard. The photosensitive sensor is integrated on the sub-circuit board. The lens assembly is connected to one side of the sub-circuit board facing away from the mainboard and disposed opposite to the photosensitive sensor, and a collecting end of the lens assembly facing away from the photosensitive sensor is exposed to the housing. The lens assembly is used for focusing external light rays entering from the collecting end on the photosensitive sensor. The photographic device can reduce the influence of heating of the mainboard on the photosensitive sensor, thereby ensuring the definition of imaging.

### FIELD

This application relates to the technical field of photographing, and more particularly relates to a photographic device.

### BACKGROUND

A photographic device, such as a monitor and a camera, achieves image acquisition through an imaging module composed of a lens assembly and a photosensitive sensor, wherein generally the photosensitive sensor of the existing photographic device is directly integrated on a mainboard thereof. However, since high-temperature heating circuit elements, such as a processor and a memory, are also integrated on the mainboard, the temperature of the mainboard increases during a working process, which will not only transfer heat to the photosensitive sensor to cause heating deformation of the photosensitive sensor, but also cause stress between the photosensitive sensor and the mainboard, and due to the influence of the heating deformation and the stress between the photosensitive sensor and the mainboard, the photosensitive sensor is liable to be out of focus, so that the definition of imaging decreases.

### SUMMARY

This application provides a photographic device which can reduce the influence of heating of a mainboard on a photosensitive sensor, thereby ensuring the definition of imaging.

According to one aspect of this application, a photographic device is provided. The photographic device includes: a housing; a mainboard disposed inside the housing, the mainboard being provided with a plurality of pillars; a sub-circuit board connected to one side of the mainboard through the plurality of pillars and having a gap with the mainboard; and an imaging module including a photosensitive sensor and a lens assembly, wherein the photosensitive sensor is integrated on the sub-circuit board, the lens assembly is connected to one side of the sub-circuit board facing away from the mainboard and disposed opposite to the photosensitive sensor, a collecting end of the lens assembly facing away from the photosensitive sensor is exposed to the housing, and the lens assembly is used for focusing external light rays entering from the collecting end on the photosensitive sensor.

Optionally, the pillar includes a first section and a second section adjoining each other, one end of the first section facing away from the second section is fixed to the mainboard, and a cross-sectional area of the first section is larger than a cross-sectional area of the second section; the sub-circuit board is sleeved on the second section and abuts against an end of the first section, so that the first section partitions the sub-circuit board from the mainboard; and a resilient member is sleeved on a part on the second section which is located on one side of the sub-circuit board facing away from the mainboard, the second section is provided with a threaded portion, a threaded fastener is connected to the threaded portion, and the threaded fastener is used for compressing the resilient member and crimping the sub-circuit board on the first section through the resilient member.

Optionally, one end of the pillar is fixed to the mainboard, and a resilient member is sleeved on the pillar; the sub-circuit board is sleeved on the pillar, so that the resilient member abuts between the sub-circuit board and the mainboard, and the gap is formed between the sub-circuit board and the mainboard; and the pillar is provided with a threaded portion, a threaded fastener is connected to the threaded portion, and the threaded fastener is used for applying a force to one surface of the sub-circuit board facing away from the mainboard, so as to compress the resilient member, so that the sub-circuit board is crimped and fixed between the threaded fastener and the resilient member.

Optionally, the lens assembly includes a lens and an encapsulation shell, the lens is at least partially disposed in the encapsulation shell, the encapsulation shell is fixedly connected to the sub-circuit board, and the collecting end is one end of the lens facing away from the photosensitive sensor; the housing is provided with a window, the collecting end is exposed to the window, and at least part of an inner edge of the window is in contact with at least part of an outer edge of the collecting end; and the resilient member is used for releasing a bending moment or torque on the sub-circuit board.

Optionally, the housing includes a first housing and a second housing which are buckled and connected with each other, the mainboard is disposed inside the first housing, the sub-circuit board is disposed on one side of the mainboard facing the second housing, and the collecting end is exposed to the second housing; and one side of the mainboard facing away from the sub-circuit board is provided with a main control unit and a storage unit, an inner wall of the first housing is convexly formed with a heat conducting platform respectively in contact with the main control unit and the storage unit, and the heat conducting platform is used for transferring heat of the main control unit and the storage unit to the first housing, so as to dissipate the heat by the first housing.

Optionally, the lens assembly includes a fisheye lens, the photosensitive sensor has a square shape, and an imaging circle diameter of the fisheye lens is less than or equal to a side length of the photosensitive sensor.

Optionally, the housing has a light-transmitting area located at the periphery of the lens assembly, a plurality of illumination modules are disposed inside the light-transmitting area, and the plurality of illumination modules are uniformly distributed at intervals along the periphery of the imaging module; and optical axes emitted by the plurality of illumination modules intersect with an optical axis of the fisheye lens, and an intersection point formed by intersection is located behind the fisheye lens.

Optionally, the photographic device further includes a bracket, wherein the bracket is connected to the housing, and the bracket is used for being fixedly connected to an external bearing member to fix the photographic device to the external bearing member.

Optionally, the other side on the housing facing away from one side for the lens assembly to be exposed is provided with a first clamping portion, and the bracket is provided with a second clamping portion; the second clamping portion forms clamping connection with the first clamping portion when the bracket rotates along a first rotation direction relative to the housing, so that the bracket and the housing are fixed to each other; and the second clamping portion is separated from the first clamping portion when the bracket rotates along a second rotation direction relative to the housing, so that the bracket and the housing are separated from each other, wherein the second rotation direction is opposite to the first rotation direction.

Optionally, one side on the housing on which the first clamping portion is located is further provided with a limiting portion, and the bracket is provided with a locking portion; the locking portion is in clamping fit with the limiting portion after the first clamping portion forms clamping connection with the second clamping portion, so as to limit the rotation of the bracket along the second rotation direction relative to the housing; and the locking portion is separated from the limiting portion when being subjected to an acting force towards a direction facing away from the housing, so as to relieve the limitation on the rotation of the bracket along the second rotation direction relative to the housing.

In the photographic device provided in this application, after the photosensitive sensor is integrated on the sub-circuit board, the lens assembly is connected to the sub-circuit board, and the sub-circuit board is fixed to the mainboard through the pillars, when the mainboard heats up during a working process, since the sub-circuit board is not in direct contact with the mainboard but has a gap with the mainboard, the heat of the mainboard cannot be directly and quickly transferred to the sub-circuit board. Moreover, the heat indirectly transferred to the sub-circuit board by the pillars and air at the gap from the mainboard is generally less, so that the temperature of the sub-circuit board cannot be greatly influenced, then heating deformation of the photosensitive sensor or stress between the sub-circuit board and the photosensitive sensor cannot be caused by an excessively high temperature of the sub-circuit board, and a greater degree of relative deviation between the photosensitive sensor and the lens assembly cannot be caused, thereby preventing the photosensitive sensor from being out of focus and ensuring the definition of imaging.

### BRIEF DESCRIPTION OF THE DRAWINGS

Various other advantages and benefits will become clear and apparent to those ordinarily skilled in the art upon reading the following detailed description of the preferred embodiments. The accompanying drawings are only for purposes of illustrating the preferred embodiments and are not to be construed as limiting this application. Moreover, like reference numerals represent like components throughout the drawings. In the drawings:

FIG. 1 is a schematic diagram of a three-dimensional structure of a photographic device provided in an embodiment of this application;

FIG. 2 is a schematic diagram of an exploded structure of the photographic device provided in an embodiment of this application;

FIG. 3A is a schematic diagram of exploded structures of a mainboard and a sub-circuit board in the photographic device provided in an embodiment of this application;

FIG. 3B is a schematic structural diagram of connection between the mainboard and the sub-circuit board in the photographic device provided in an embodiment of this application;

FIG. 4 is a schematic diagram of a variant structure of the connection between the mainboard and the sub-circuit board in the photographic device provided in an embodiment of this application;

FIG. 5A is a schematic diagram of the exploded structures of the mainboard and the sub-circuit board in the photographic device provided in another embodiment of this application;

FIG. 5B is a schematic structural diagram of the connection between the mainboard and the sub-circuit board in the photographic device provided in another embodiment of this application;

FIG. 6 is a schematic diagram of the variant structure of the connection between the mainboard and the sub-circuit board in the photographic device provided in another embodiment of this application;

FIG. 7 is a schematic diagram of the exploded structure of the photographic device provided in an embodiment of this application;

FIG. 8 is a schematic diagram of a cross-sectional structure of the photographic device provided in an embodiment of this application;

FIG. 9 is a schematic diagram of imaging on a photosensitive sensor in a driving fisheye photographic device;

FIG. 10 is a schematic diagram of imaging on the photosensitive sensor in the photographic device provided in an embodiment of this application;

FIG. 11 is a schematic diagram of a light path for supplementary light of an illumination module in the photographic device provided in an embodiment of this application;

FIG. 12 is a schematic diagram of the three-dimensional structure of the photographic device provided in an embodiment of this application from another angle of view;

FIG. 13 is a schematic diagram of exploded structures of part of a housing and a bracket in the photographic device provided in an embodiment of this application from one angle of view;

FIG. 14 is a schematic diagram of exploded structures of part of the housing and the bracket in the photographic device provided in an embodiment of this application from another angle of view; and

FIG. 15 is a schematic diagram of the exploded structure of the photographic device provided in an embodiment of this application from another angle of view.

### DETAILED DESCRIPTION

Embodiments of this application will be described in detail below, and examples of the embodiments are illustrated in the accompanying drawings, wherein same or similar reference numerals refer to same or similar elements, or elements with same or similar functions throughout the drawings. The embodiments described below with reference to the accompanying drawings are exemplary only to explain the embodiments of this application and should not be construed as limiting the embodiments of this application.

A photosensitive sensor is an important constituent part of a photographic device, which is mainly used for converting a received optical signal into an electrical signal. In the production and preparation processes of the photographic device, generally the photosensitive sensor is directly encapsulated on a mainboard through a process such as welding or adhesion, and a lens assembly is fixedly connected to one side on the mainboard on which the photosensitive sensor is located and disposed opposite to the photosensitive sensor, so that external light rays are focused on the photosensitive sensor after entering the lens assembly.

The temperature of the mainboard will rise during a working process due to the influence of heating of circuit elements on the mainboard, on the one hand, the heat will be transferred to the photosensitive sensor, resulting in the deformation of the photosensitive sensor; and on the other hand, the stress will be generated between the photosensitive sensor and the mainboard, and both the deformation of the photosensitive sensor and the stress generated between the photosensitive sensor and the mainboard may cause the displacement of the photosensitive sensor relative to the lens assembly, resulting in the deviation of the photosensitive sensor from a lens focus, thereby influencing the definition of imaging.

In order to avoid the influence of the heating of the mainboard on the photosensitive sensor, a structural design is adopted in which the photosensitive sensor is separated from the mainboard; specifically, the photosensitive sensor is encapsulated on the sub-circuit board, and the lens assembly is connected to the sub-circuit board, wherein the sub-circuit board serves as a carrier of an imaging module composed of the photosensitive sensor and the lens assembly, while the sub-circuit board is connected to the mainboard through pillars and has a gap with the mainboard, so that the sub-circuit board and a photosensitive element thereon are in a suspended state, so as to prevent excessive heat from being transferred from the mainboard to the sub-circuit board, and to reduce the influence of the heating of the mainboard on the photosensitive sensor, thereby ensuring the accuracy and reliability of the relative position between the photosensitive sensor and the lens assembly, and ensuring the clear imaging.

One embodiment of this application provides a photographic device, which may be, for example, a monitor, a camera, and the like. The photographic device includes, but is not limited to, applications in the fields of security monitoring, medical diagnosis, smart home, traffic control, and the like.

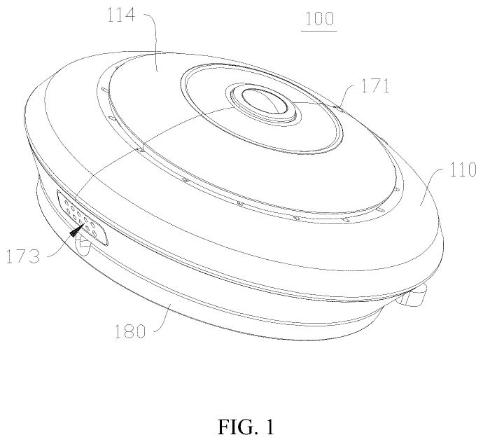

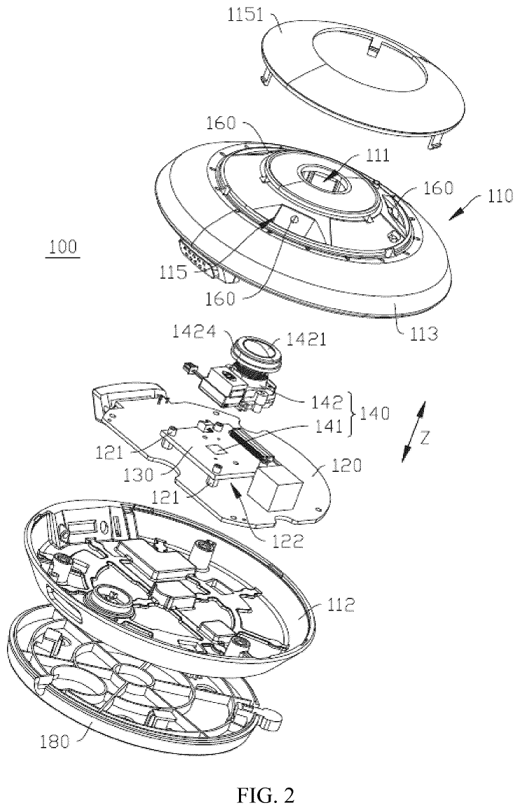

FIG. 1 shows a three-dimensional structure of the photographic device, and FIG. 2 shows an exploded structure of the photographic device. As shown in FIG. 1 and FIG. 2, the photographic device 100 includes a housing 110, a mainboard 120, a sub-circuit board 130, and an imaging module 140. The mainboard 120 is disposed inside the housing 110, the mainboard 120 is provided with a plurality of pillars 121, and the sub-circuit board 130 is connected to one side of the mainboard 120 through the plurality of pillars 121 and has a gap 122 with the mainboard 120. The imaging module 140 includes a photosensitive sensor 141 and a lens assembly 142. The photosensitive sensor 141 is integrated on the sub-circuit board 130. The lens assembly 142 is connected to one side of the sub-circuit board 130 facing away from the mainboard 120 and disposed opposite to the photosensitive sensor 141, and a collecting end 1421 of the lens assembly 142 facing away from the photosensitive sensor 141 is exposed to the housing 110. The lens assembly 142 is used for focusing external light rays entering from the collecting end 1421 on the photosensitive sensor 141.

The mainboard 120 is used for integrating circuit structures, such as a main control module, a power supply module, and a storage module for achieving required functions of the photographic device 100. The housing 110 serves as a carrier for direct or indirect mounting of the mainboard 120, the sub-circuit board 130 and the imaging module 140, and the housing 110 is used for providing a protection function for these components. Specifically, the housing 110 may consist of a plurality of parts which are detachable from each other to facilitate the mounting of corresponding components in the housing 110.

In addition to integrating the photosensitive sensor 141 on the sub-circuit board 130, a circuit for inputting power to the photosensitive sensor 141 and a circuit for transmitting an electric signal output from the photosensitive sensor 141 to the mainboard 120 may be integrated.

The imaging principle of the photographic device 100 is as follows: after external light rays enter the lens assembly 142 from the collecting end 1421, the lens assembly 142 refracts and focuses the light rays on the photosensitive sensor 141 to form an optical image, and the photosensitive element of the photosensitive sensor 141 generates an electrical signal of a corresponding magnitude according to the intensity of the light rays received by the photosensitive element and outputs the electrical signal, and the electrical signal may be converted into corresponding image data after subsequent processing.

After the photosensitive sensor 141 is integrated on the sub-circuit board 130, the lens assembly 142 is connected to the sub-circuit board 130, and the sub-circuit board 130 is fixed to the mainboard 120 through the pillars 121, when the mainboard 120 heats up during a working process, since the sub-circuit board 130 is not in direct contact with the mainboard 120 but has a gap 122 with the mainboard 120, the heat of the mainboard 120 cannot be directly and quickly transferred to the sub-circuit board 130. The heat indirectly transferred to the sub-circuit board 130 by the pillars 121 and air at the gap 122 from the mainboard 120 is generally less, so that the temperature of the sub-circuit board 130 cannot be greatly influenced, then heating deformation of the photosensitive sensor 141 or stress between the sub-circuit board 130 and the photosensitive sensor 141 cannot be caused by an excessively high temperature of the sub-circuit board 130, and a greater degree of relative deviation between the photosensitive sensor 141 and the lens assembly 142 cannot be caused, thereby preventing the photosensitive sensor 141 from being out of focus and ensuring the definition of imaging.

If the sub-circuit board 130 is displaced, the photosensitive sensor 141 and the lens assembly 142 are driven to move synchronously. Namely, there is no relative displacement between the photosensitive sensor 141 and the lens assembly 142, and the definition of imaging is not influenced. However, if stress is generated between the photosensitive sensor 141 and the sub-circuit board 130, longitudinal relative displacement between the photosensitive sensor 141 and the lens assembly 142 may occur, which is extremely likely to cause a greater degree of deviation of the photosensitive sensor 141 from a focal point of the lens assembly 142, resulting in blurred imaging. However, the following cases may cause stress between the sub-circuit board 130 and the photosensitive sensor 141:
(1). the heating deformation of the mainboard 120 causes the acting forces applied to the sub-circuit board 130 by various pillars 121 to be non-uniform, so that the sub-circuit board 130 deforms itself due to the presence of a bending moment or torque, and then the stress is generated between the sub-circuit board 130 and the photosensitive sensor 141; and
(2). the housing 110, the mainboard 120, the sub-circuit board 130, and the imaging module 140 generate an acting force between each other after assembly, resulting in deformation of the sub-circuit board 130 itself due to the presence of the bending moment or torque, thereby generating stress between the sub-circuit board 130 and the photosensitive sensor 141.

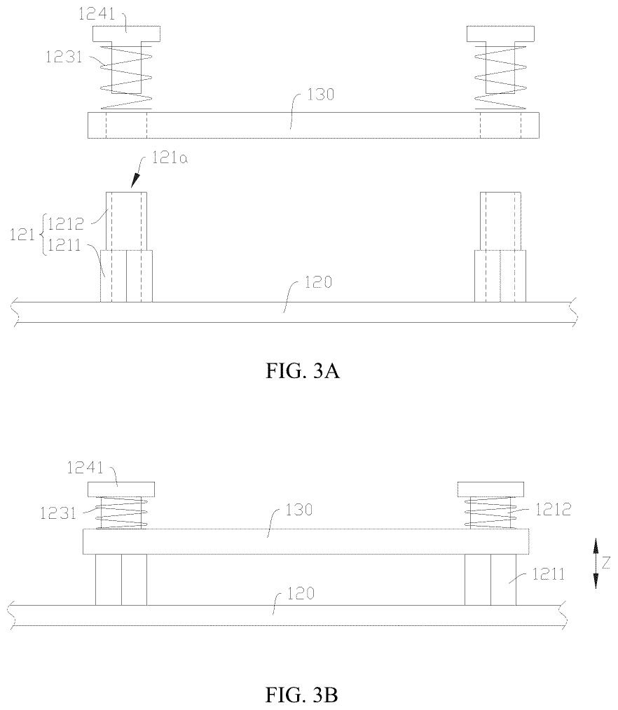

With regard to the above cases, in order to avoid the stress generated between the sub-circuit board 130 and the photosensitive sensor 141 as much as possible, this application provides an embodiment, FIG. 3A shows exploded structures of the mainboard 120 and the sub-circuit board 130 from a side angle of view, and FIG. 3B shows a connection structure from the side angle of view. As shown in FIG. 3A and FIG. 3B, the pillar 121 includes a first section 1211 and a second section 1212 adjoining each other, one end of the first section 1211 facing away from the second section 1212 is fixed to the mainboard 120, and a cross-sectional area of the first section 1211 is larger than a cross-sectional area of the second section 1212. The sub-circuit board 130 is sleeved on the second section 1212 and abuts against an end of the first section 1211, so that the first section 1211 partitions the sub-circuit board 130 from the mainboard 120. A resilient member 1231 is sleeved on a part on the second section 1212 which is located on one side of the sub-circuit board 130 facing away from the mainboard 120, the second section 1212 is provided with a threaded portion 121a (which may be, for example, a threaded hole shown in the drawing), a threaded fastener 1241 is connected to the threaded portion 121a, and the threaded fastener 1241 is used for compressing the resilient member 1231 and crimping the sub-circuit board 130 on the first section 1211 through the resilient member 1231.

Referring to FIG. 3A, when the sub-circuit board 130 is assembled on the mainboard 120, the sub-circuit board 130 is sleeved on the second section 1212 of the pillar 121, and a bottom surface of the sub-circuit board 130 abuts against a top surface of the first section 1211 of the pillar 121 to achieve the pre-positioning of the sub-circuit board 130, and in this case, the second section 1212 partially protrudes from a top surface of the sub-circuit board 130. Then, the resilient member 1231 is sleeved on the second section 1212 from the top, and the threaded fastener 1241 is connected to the threaded portion 121a of the second section 1212, and the resilient member 1231 is compressed and clamped between a head of the threaded fastener 1241 and the top surface of the sub-circuit board 130 by the threaded fastener 1241 in a state shown in FIG. 3B, so as to achieve the assembly and fixation of the sub-circuit board 130 on the mainboard 120.

The resilient member 1231 is used for releasing the bending moment or torque on the sub-circuit board 130, and specifically, on the basis of the structure shown in FIG. 3B, when the sub-circuit board 130 deforms itself due to the bending moment or torque, the structural characteristics of the sub-circuit board 130 itself will cause the sub-circuit board 130 to have a tendency to recover the deformation, and this tendency will cause the sub-circuit board 130 to apply an acting force to the resilient member 1231 at the corresponding position, and the resilient member 1231 elastically deforms under the acting force, so as to release the bending moment or torque on the sub-circuit board 130, and recover the deformation of the sub-circuit board 130. On this basis, it can ensure that basically no stress is generated between the sub-circuit board 130 and the photosensitive sensor 141, thereby ensuring that the relative position between the photosensitive sensor 141 and the lens assembly 142 is always accurate and reliable, and providing guarantee for clear imaging.

In addition, when the pillar 121 is influenced (for example, subjected to shrinkage deformation itself or driven by the shrinkage deformation of the mainboard 120) to generate a gap with the sub-circuit board 130 along a longitudinal direction, the compressed resilient member 1231 provides pressure to the sub-circuit board 130 to tightly press the sub-circuit board 130 between the resilient member 1231 and the second section 1212, thereby ensuring the structural stability of the sub-circuit board 130.

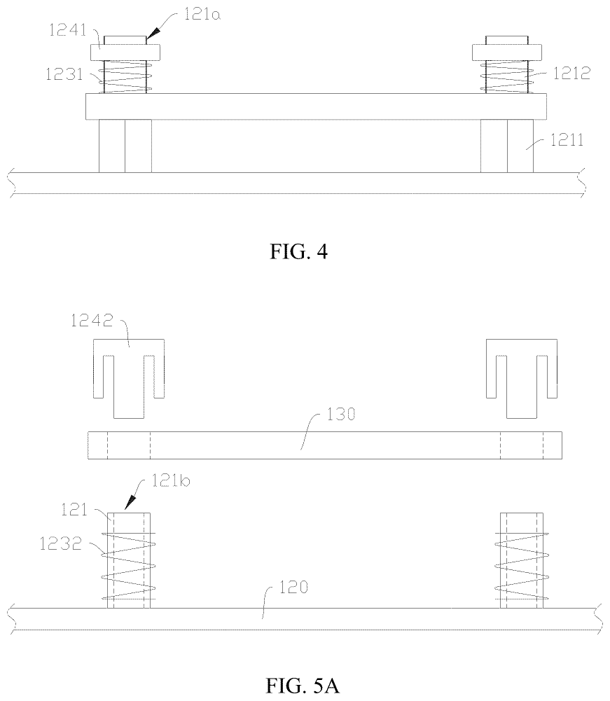

With regard to the specific structures of the threaded portion 121a and the threaded fastener 1241, it should be noted that the threaded portion 121a may be the threaded hole as shown in FIG. 3A, and correspondingly, the threaded fastener 1241 may be a screw as shown in FIG. 3A. Of course, in some other embodiments, as shown in FIG. 4, the threaded portion 121a may also be threads disposed at the periphery of the second section 1212, namely, the second section 1212 may be a threaded rod, and the threaded fastener 1241 may correspondingly be a nut sleeved on the second section 1212. In this embodiment, the principle for assembling and fixing the sub-circuit board 130 and releasing the bending moment or torque on the sub-circuit board 130 is the same as that of the example shown in FIG. 3A and FIG. 3B, and will not be described in detail herein.

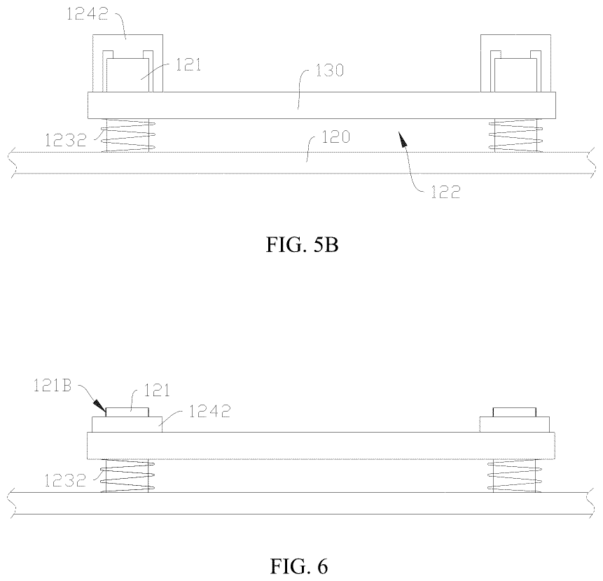

With regard to the case where the stress between the sub-circuit board 130 and the photosensitive sensor 141 is avoided as much as possible, this application further provides another embodiment, specifically referring to FIG. 5A and FIG. 5B, FIG. 5A shows exploded structures of the mainboard 120 and the sub-circuit board 130 from a side angle of view, and FIG. 5B shows a connection structure from the side angle of view. As shown in the drawings, one end of the pillar 121 is fixed to the mainboard 120, and the resilient member 1232 is sleeved on the pillar 121. The sub-circuit board 130 is sleeved on the pillar 121, so that the resilient member 1232 abuts between the sub-circuit board 130 and the mainboard 120, and the gap 122 is formed between the sub-circuit board 130 and the mainboard 120. The pillar 121 is provided with a threaded portion 121b (which may be, for example, a threaded hole shown in the drawing), and a threaded fastener 1242 is connected to the threaded portion 121b, and the threaded fastener 1242 is used for applying a force to one side of the sub-circuit board 130 facing away from the mainboard 120 to compress the resilient member 1232, so that the sub-circuit board 130 is crimped and fixed between the threaded fastener 1242 and the resilient member 1232.

The embodiments shown in FIG. 5A and FIG. 5B differ from the embodiments shown in FIG. 3A and FIG. 3B in that the resilient member 1232 abuts between the bottom surface of the sub-circuit board 130 and the top surface of the mainboard 120, and the principle of releasing the bending moment or torque on the sub-circuit board 130 by the resilient member 1232 is consistent with the above description of the related principle in the examples shown in FIG. 3A and FIG. 3B, which will not be described in detail herein.

It should also be noted that in FIG. 5A and FIG. 5B, the threaded portion 121b is a threaded hole formed in the pillar 121, and the threaded fastener 1242 is a screw having a downward extending part at the head edge, and the threaded fastener 1242 is crimped to the sub-circuit board 130 through the downward extending part at the head edge. As shown in FIG. 6, in some other embodiments, the threaded portion 121b may also be threads at the periphery of the pillar 121, namely, the pillar 121 may be a stud, and the threaded fastener 1242 may be a nut sleeved on the threaded portion 121b.

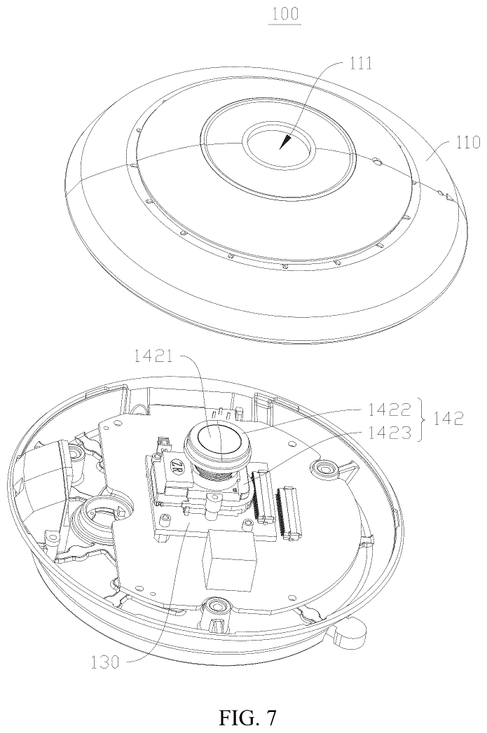

With regard to the case where the bending moment or torque formed on the sub-circuit board 130 due to the acting force generated by the assembly is released by the resilient member 1231 and/or the resilient member 1232. Specifically referring to FIG. 7, the exploded structure of the photographic device is shown in FIG. 7. The lens assembly 142 includes a lens 1422 and an encapsulation shell 1423, wherein the lens 1422 is at least partially disposed in the encapsulation shell 1423, the encapsulation shell 1423 is fixedly connected to the sub-circuit board 130, and the collecting end 1421 is one end of the lens 1422 facing away from the photosensitive sensor 141 (referring to FIG. 2). The housing 110 is provided with a window 111, the collecting end 1421 is exposed to the window 111, and at least part of an inner edge of the window 111 is in contact with at least part of an outer edge of the collecting end 1421. Each of the resilient member 1231 and the resilient member 1232 (referring to FIG. 3A to FIG. 6) is used for releasing the bending moment or torque on the sub-circuit board 130.

It will be understood that in the absence of manufacturing errors and assembly errors, the inner edge of the window 111 and the outer edge of the collecting end 1421 should be in contact but have no mutual acting force after the assembly of the photographic device 100 is completed.

The above case, after all, is an ideal case. In actual production and assembly processes, influenced by the manufacturing errors and the assembly errors, the mutual acting force will be inevitably formed due to the extrusion between at least part of the inner edge of the window 111 and at least part of the outer edge of the collecting end 1421. However, in the mutual acting force, the force acting on the lens 1422 is transferred to the encapsulation shell 1423 from the lens 1422, and then transferred to the sub-circuit board 130 from the encapsulation shell 1423; and if the sub-circuit board 130 is rigidly connected to various pillars 121, acting forces of different magnitudes and directions are generated between the sub-circuit board 130 and different pillars 121, thereby forming a bending moment or torque on the sub-circuit board 130.

Based on the above problems, in order to avoid the deformation of the sub-circuit board 130 caused by the formed bending moment or torque to affect the relative position between the photosensitive sensor 141 and the lens assembly 142, the elastic deformation of the resilient member 1231 and the resilient member 1232 shown in FIG. 3A to FIG. 6 may be utilized for adjusting the stress condition of the sub-circuit board 130 at different pillars 121, so as to ensure that the overall stress on the sub-circuit board 130 is uniform, and no bending moment or torque is generated, thereby ensuring the relative position between the photosensitive sensor 141 and the lens assembly 142.

In addition, it should be emphasized that the inner edge of the window 111 is in contact with the outer edge of the collecting end 1421, the two may be in direct contact, or a sealing ring (not shown in the drawing) may be sandwiched between the inner edge of the window 111 and the outer edge of the collecting end 1421, the inner edge of the window 111 and the outer edge of the collecting end 1421 are in indirect contact through the sealing ring, and the sealing ring is mainly used for closing a gap between the inner edge of the window 111 and the outer edge of the collecting end 1421 due to the manufacturing and assembly errors, so as to improve the waterproof performance of the photographic device 100.

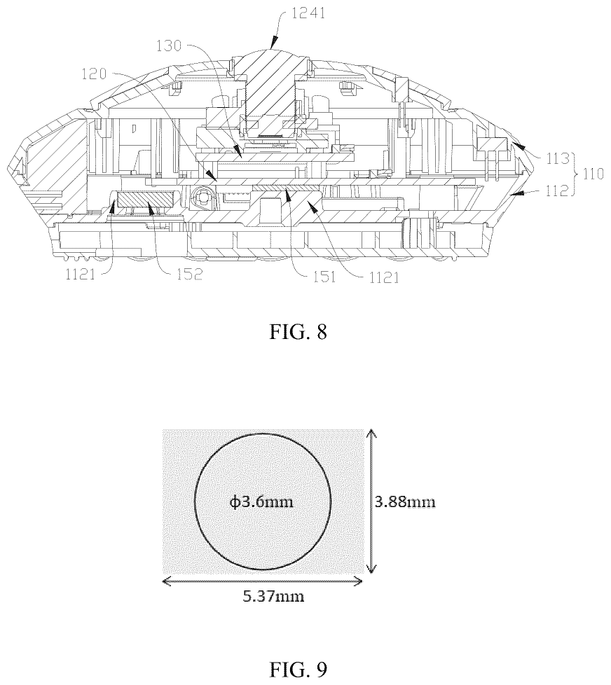

In order to improve the heat dissipation effect of the photographic device 100 and prevent the sub-circuit board 130 from being heated and deformed due to the excessively high internal temperature of the housing 110 as much as possible, this application further provides an embodiment, specifically referring back to FIG. 2, and further in conjunction with FIG. 8, FIG. 8 shows a sectional structure of the photographic device. As shown in the drawing, the housing 110 includes a first housing 112 and a second housing 113 which are buckled and connected with each other, the mainboard 120 is disposed inside the first housing 112, the sub-circuit board 130 is disposed on one side of the mainboard 120 facing the second housing 113, and the collecting end 1421 is exposed to the second housing 113. One side of the mainboard 120 facing away from the sub-circuit board 130 is provided with a main control unit 151 and a storage unit 152, an inner wall of the first housing 112 is convexly formed with a heat conducting platform 1121 respectively in contact with the main control unit 151 and the storage unit 152, and the heat conducting platform 1121 is used for transferring heat of the main control unit 151 and the storage unit 152 to the first housing 112, so as to dissipate the heat by the first housing 112.

The main control unit 151 is a processor, and the storage unit 152 may be a double data rate (DDR for short) synchronous dynamic random access memory. The amount of heating of the main control unit 151 and the storage unit 152 is relatively large during working, so that the main control unit 151 and the storage unit 152 are main elements influencing the internal temperature of the housing 110. In order to efficiently dissipate the heat of the main control unit 151 and the storage unit 152, in this embodiment, the first housing 112 is convexly provided with the heat conducting platform 1121 respectively in contact with the main control unit 151 and the storage unit 152, so that the heat generated by the main control unit 151 and the storage unit 152 is timely conducted to the first housing 112 by the heat conducting platform 1121, and then emitted by the first housing 112 to the outside, thereby achieving efficient heat dissipation for the main control unit 151 and the storage unit 152, and avoiding the influence of the excessively high internal temperature of the housing 110 on the sub-circuit board 130 and the photosensitive sensor 141 thereon as much as possible.

Further, the first housing 112 may be made of a material having good thermal conductivity, for example, a metal material such as copper or aluminum, so as to improve the heat dissipation efficiency of the photographic device 100.

In the field of security monitoring, a fisheye lens has been widely applied in smart home, home security monitoring and other aspects due to the feature of a large field of view (180° or even larger field of view may be obtained) thereof, so as to achieve omnidirectional monitoring. At present, most photographic devices using fisheye lenses adopt a relatively short focal length and a large distortion lens in combination with a conventional photosensitive sensor with a size ratio of 4:3 for imaging, which results in a relatively small number of pixels per unit angle and relatively low definition. Specifically referring to FIG. 9, the drawing shows a schematic diagram of imaging on the photosensitive sensor after the fisheye lens having a focal length of 1.22 mm and an imaging circle diameter of 3.6 mm in the conventional fisheye photographic device is matched with the photosensitive sensor with a pixel point size of 2 μm and a size ratio of 4:3. As shown in the drawing, when imaging at 180° field of view is achieved, the effective pixel (a ratio of the area of the imaging circle to the area of the photosensitive sensor) is only 48.8%, the edge area of photosensitive sensor is wasted greatly, and the average field of view per degree occupies only 0.02 mm image height of the photosensitive sensor, namely, 20 μm/°=10 pixels/° (i.e., 20 μm/degree=10 pixels/degree), resulting in relatively low definition.

In order to improve the definition of imaging, this application further provides an embodiment, and specifically referring to FIG. 2 again, the lens assembly 142 includes a fisheye lens 1424, the photosensitive sensor 141 is in a forward direction, and an imaging circle diameter of the fisheye lens 1424 is less than or equal to a side length of the photosensitive sensor 141.

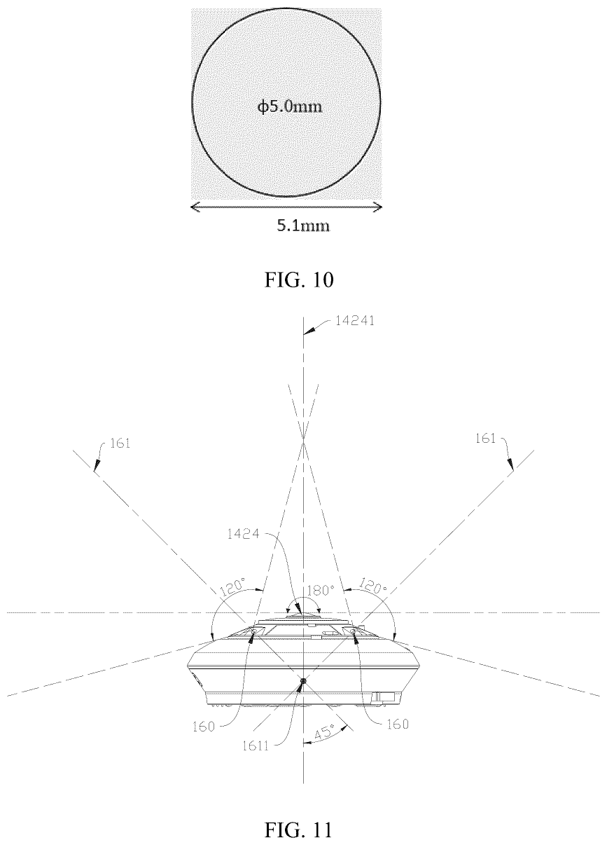

Referring to FIG. 10, the drawing shows a schematic diagram of imaging on the photosensitive sensor after the fisheye lens having a focal length of 2.0 mm and an imaging circle diameter of 5.0 mm is matched with the photosensitive sensor with a pixel point size of 2 μm and a size ratio of 1:1. When imaging at 180° field of view is achieved, the effective pixel may be increased to 75%, the edge area of photosensitive sensor is less wasted, and the average field of view per degree occupies 0.03 mm image height of the photosensitive sensor, namely, 30 μm/°=15 pixel/° (i.e., 30 μm/degree=15 pixel/degree), so that the definition of the photographic device can be effectively improved. It is to be understood that FIG. 10 is merely one specific embodiment provided in this application and that reference to specific parameters does not constitute a limitation on this application.

With regard to the case where the fisheye lens 1424 may be used for imaging with a large field of view, in order to effectively supplement light for the whole field of view in the case where the brightness of the external environment is relatively low, specifically referring to FIG. 1 and FIG. 2, the housing 110 has a light-transmitting area 114 located at the periphery of the lens assembly 142, a plurality of illumination modules 160 are disposed inside the light-transmitting area 114, and the plurality of illumination modules 160 are uniformly distributed at intervals along the periphery of the imaging module 140.

Further referring to FIG. 11, a schematic diagram of lighting of the illumination modules is shown in FIG. 11. Optical axes 161 of the plurality of illumination modules 160 intersect with an optical axis 14241 of the fisheye lens, and an intersection point 1611 formed by intersection is located behind the fisheye lens 1424 (namely, below the fisheye lens 1424 in FIG. 11).

In FIG. 11, by taking the field of view of the fisheye lens 1424 being 180° (a double-dot dash line represents the edge of the field of view of the fisheye lens 1424), an included angle formed by the optical axis 161 of each illumination module 160 and the optical axis 14241 of the fisheye lens 1424 being 45°, and a divergence angle of the illumination module 160 being 120° (a dotted line represents the divergence angle of the illumination module 160) as an example, as shown in FIG. 11, after the light rays emitted by a plurality of illumination modules 160 within a range of the divergence angle are combined, the field of view of the fisheye lens 1424 can be completely covered, so as to achieve effective light supplementation for the external environment, thereby ensuring the brightness and definition collected by the fisheye lens 1424. It is preferable to supplement the light by adopting three illumination modules 160 uniformly distributed along a circumferential direction.

An infrared lamp is generally adopted as the illumination module 160, and the infrared lamp can work without visible light outside the photographic device 100. Specifically, in a night vision photographing scene, infrared rays emitted by the infrared lamp irradiate an object surface, and after being reflected by the object surface, these infrared rays are received by the fisheye lens 1424, so as to form a video image.

It should be noted that in FIG. 1 and FIG. 2, the illumination module 160 is disposed inside the housing 110, the housing 110 is provided with a light outlet 115 for the illumination module 160 to be exposed, the outside of the housing is covered with a light-transmitting baffle plate 1151 at the light outlet 115, the light-transmitting baffle plate 1151 covers the outside of the illumination module 160 to provide protection for the illumination module 160, the light-transmitting baffle plate 1151 forms the above light-transmitting area 114, and the light rays emitted by the illumination module 160 reach the outside through the light-transmitting baffle plate 1151. Of course, it is to be understood that the area on the housing 110 corresponding to the illumination module 160 may also be directly provided with a light-transmitting material to form the light-transmitting area 114.

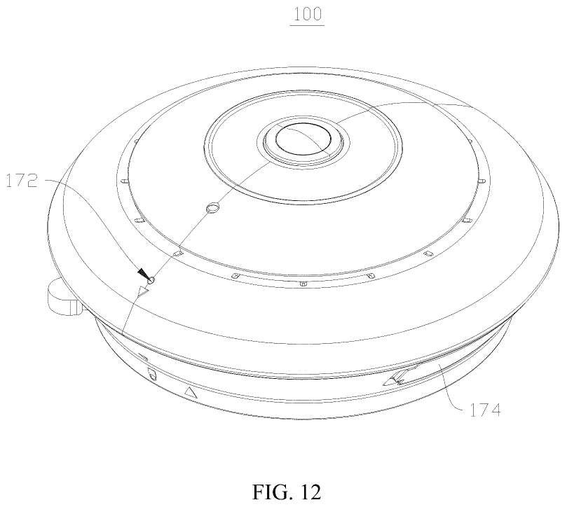

Further, as shown in FIG. 1, the housing 110 may also be provided with a hole for mounting an ambient light sensor 171, and the ambient light sensor 171 is used for detecting the intensity of external light rays and enabling the photographic device 100 to timely turn on the illumination module 160 to supplement light when the intensity of the external light rays is insufficient. Referring to FIG. 12, which shows the three-dimensional structure of the photographic device from another angle of view. The housing 110 may also be provided with a hole for mounting a microphone 172 to receive sound from the outside. In addition, continuing to refer to FIG. 1 and FIG. 12, the housing 110 may also be provided with a loudspeaker 173 and a card slot cover 174, wherein the loudspeaker 173 is used for emitting sound, the card slot cover 174 is used for closing an internal memory card slot, and the memory card slot is used for accommodating a memory card, such as an SD card.

When the photographic device 100 is used as a monitor, in order to fix the photographic device 100 in various mounting manners, such as lifting, wall mounting and plane placing, this application further provides an example, specifically referring to FIG. 1 and FIG. 2 again. The photographic device 100 further includes a bracket 180, wherein the bracket 180 is connected to the housing 110, and the bracket 180 is used for being fixedly connected to an external bearing member (not shown in the drawings, which may be, for example, a suspended ceiling, a wall surface, a desktop, and the like), so as to fix the photographic device 100 to the external bearing member.

Specifically, the bracket 180 may be fixed to the external bearing member by means of hanging, threaded fastener connection, clamping connection, bonding, and the like, which is not limited herein.

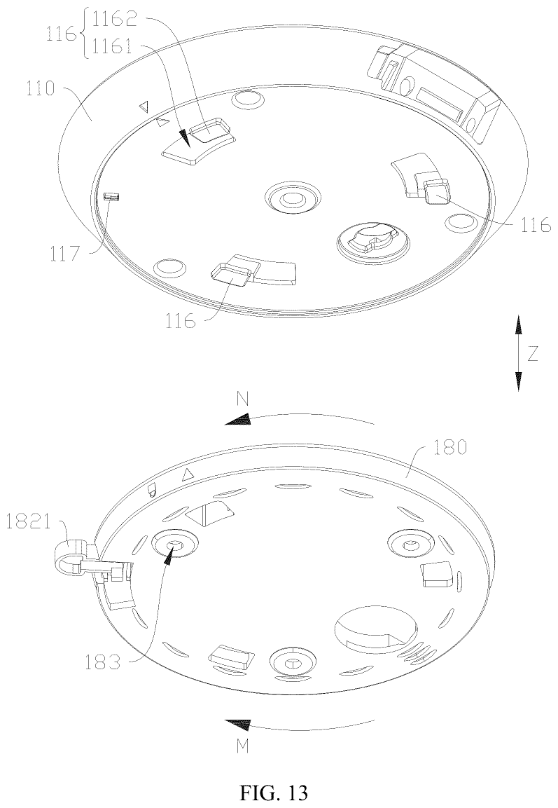

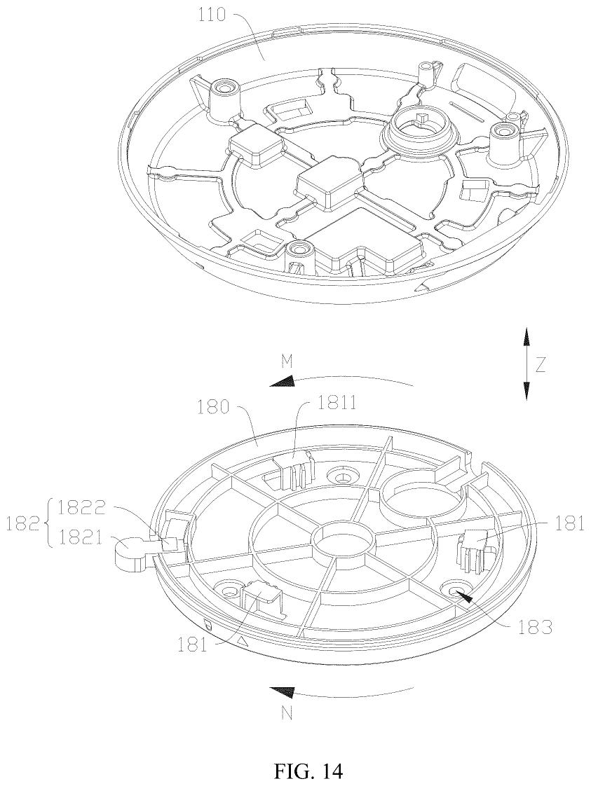

With regard to the assembly of the bracket 180 and the housing 110, this application provides an embodiment, specifically referring to FIG. 13 and FIG. 14, the drawings show the explosive structures of the bracket and part of the housing from two angles of view, respectively. The other side on the housing 110 facing away from one side for the lens assembly 142 to be exposed is provided with a first clamping portion 116, and the bracket 180 is provided with a second clamping portion 181. The second clamping portion 181 forms clamping connection with the first clamping portion 116 when the bracket 180 rotates along a first rotation direction (a direction indicated by a rotation arrow M in the drawing) relative to the housing 110, so that the bracket 180 and the housing 110 are fixed to each other. The second clamping portion 181 is separated from the first clamping portion 116 when the bracket 180 rotates along a second rotation direction (a direction indicated by a rotation arrow N in the drawing) relative to the housing 110, so that the bracket 180 and the housing 110 are separated from each other.

In FIG. 13 and FIG. 14, the first clamping portion 116 includes a sliding chute 1161 and a first clamping plate 1162, wherein the first clamping plate 1162 covers part of a notch of the sliding chute 1161, and the second clamping portion 181 is a second clamping plate 1811 convexly disposed. When the bracket 180 and the housing 110 are assembled, firstly the second clamping plate 1811 extends into the sliding chute 1161 from the notch of the sliding chute 1161, and then the bracket 180 is rotated along the direction indicated by the rotation arrow M, so that the second clamping plate 1811 forms clamping connection with the first clamping plate 1162 along the direction indicated by the double-headed arrow Z, thereby fixing the bracket 180 on the housing 110, and the whole assembly operation is convenient and quick. The reverse operation is performed during disassembly, firstly the bracket 180 is rotated along the direction indicated by the rotation arrow N, so that the second clamping plate 1811 is staggered from the first clamping plate 1162, and then the bracket 180 is moved, so that the second clamping plate 1811 is removed from the sliding chute 1161, and the operation is also convenient and quick during disassembly.

Further, in order to ensure the firmness of the connection between the bracket 180 and the housing 110, a plurality of first clamping portions 116 and second clamping portions 181 may be disposed, respectively. In the examples shown in FIG. 13 and FIG. 14, three first clamping portions 116 and three second clamping portions 181 are disposed along the circumferential direction.

In order to prevent the bracket 180 from being disengaged from the housing 110 due to incorrect rotation, this application further provides an embodiment, specifically continuing to refer to FIG. 13 and FIG. 14, one side on the housing 110 on which the first clamping portion 116 is located is further provided with a limiting portion 117, and the bracket 180 is provided with a locking portion 182. The locking portion 182 is in clamping fit with the limiting portion 117 after the first clamping portion 116 forms clamping connection with the second clamping portion 181, so as to limit the rotation of the bracket 180 along the second rotation direction relative to the housing 110. The locking portion 182 is separated from the limiting portion 117 when being subjected to an acting force towards a direction facing away from the housing 110, so as to relieve the limitation on the rotation of the bracket 180 along the second rotation direction relative to the housing 110.

Specifically, as shown in FIG. 13 and FIG. 14, the limiting portion 117 is a first clamping block disposed on the housing 110, and the locking portion 182 includes a cantilever 1821 disposed on a side surface of the bracket 180 and a second clamping block 1822 disposed on one surface of the cantilever 1821 facing the housing 110. After the bracket 180 rotates along the direction indicated by the rotation arrow M relative to the housing 110 to enable the second clamping portion 181 to be in clamping connection with the first clamping portion 116 along the direction indicated by the double-headed arrow Z, the second clamping block 1822 may also form clamping connection with the first clamping block (the limiting portion 117) along the direction indicated by the rotation arrow N, thereby limiting the rotation of the bracket 180 along the direction indicated by the rotation arrow N relative to the housing 110 by the clamping connection between the second clamping block 1822 and the first clamping block (e.g., the limiting portion 117), and preventing the bracket 180 from being disengaged from the housing 110 due to incorrect rotation.

After limiting the relative rotation of the bracket 180 and the housing 110, the disassembly operation between the bracket 180 and the housing 110 may be easily achieved by the cantilever 1821. Specifically, during disassembly, the cantilever 1821 is pressed downwards along a pointing direction facing away from the housing 110 in the direction indicated by the double-headed arrow Z to separate the second clamping block 1822 from the first clamping block (e.g., the limiting portion 117), and then the bracket 180 is rotated along the direction indicated by the rotation arrow N while the cantilever 1821 is maintained to be pressed downwards, so that the disassembly and separation of the bracket 180 from the housing 110 may be achieved.

With regard to the above mounting and dismounting operation of the bracket 180 and the housing 110, the description is provided by taking the operation of the angle of movement of the bracket 180 relative to the housing 110 as an example, and it can be understood that in some scenes, such as a suspended ceiling, wall hanging, and the like, the bracket 180 is fixed to an external bearing member, and in this case, the movement of the housing 110 relative to the bracket 180 is operated to achieve the mounting or dismounting of the two, specifically in the same manner as the above description, which will not be described in detail herein.

Further, as shown in FIG. 13 and FIG. 14, the bracket 180 may be provided with a mounting hole 183, and the bracket 180 is connected to the threaded fastener through the mounting hole 183 to achieve the connection between the bracket 180 and the external bearing member, such as a suspended ceiling, a wall surface, a desktop, and the like, so as to fix the photographic device 100 at a designated position.

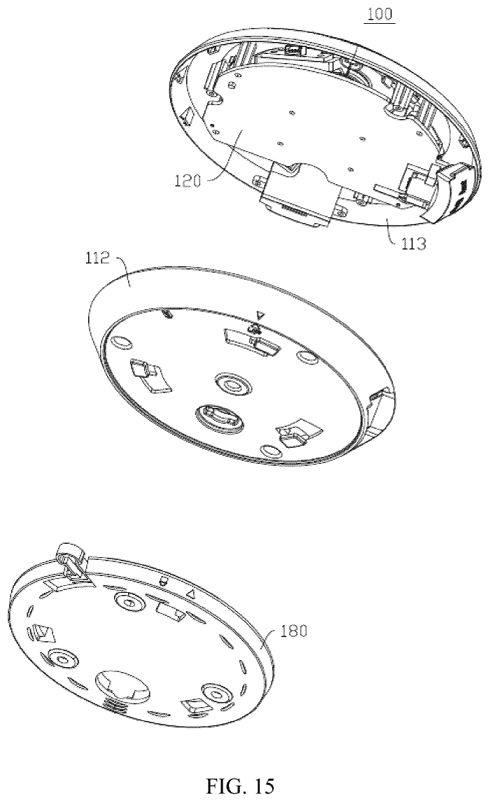

Referring to FIG. 2 again and further in conjunction with FIG. 15, which shows the exploded structure of the photographic device from a bottom angle of view. As shown in FIG. 2 and FIG. 15, in some embodiments, the assembling steps of the photographic device 100 are as follows.

Firstly, as shown in FIG. 2, the lens assembly 142 is mounted and fixed at a corresponding position on the sub-circuit board 130, so that the lens assembly 142 and the photosensitive sensor 141 integrated on the sub-circuit board 130 constitute the imaging module 140 together.

Secondly, as shown in FIG. 2, the sub-circuit board 130 with the imaging module 140 is connected to a plurality of pillars 121, so that the sub-circuit board 130 is mounted and fixed to the mainboard 120.

Next, as shown in FIG. 2 and FIG. 3, the module composed of the mainboard 120 and the sub-circuit board 130 is at least partially accommodated in the second housing 113, so that after the collecting end 1421 is aligned with and exposed to the window 111 in the second housing 113, the mainboard 120 is fixed to a fixing pillar in the second housing 113 by the threaded fastener, and in this case, the mainboard 120, the sub-circuit board 130, the imaging module 140, and the second housing 113 constitute a whole.

Then, the first housing 112 is buckled to the bottom of the second housing 113, and the first housing 112 and the second housing 113 are connected and fixed by the threaded fastener, thereby forming a main body of the photographic device 100.

Finally, the assembly of the photographic device 100 is completed by rotating the bracket 180 to couple and lock the bracket 180 to the first housing 112.

It should be noted that the above various embodiments are merely illustrative of the technical solutions of this application, rather than limiting the technical solutions; although this application has been described in detail with reference to the foregoing embodiments, those ordinarily skilled in the art will understand that the technical solutions disclosed in the above embodiments may still be modified, or some or all of the technical features thereof may be substituted with equivalents; however, these modifications or substitutions do not bring the essence of the corresponding technical solutions out of the scope of the technical solutions of the various embodiments of this application. Especially, the technical features mentioned in the various embodiments may be combined in any manner as long as there is no structural conflict.

What is claimed is:

1. A photographic device, comprising:
a housing;
a mainboard disposed inside the housing, the mainboard being provided with a plurality of pillars;
a sub-circuit board connected to one side of the mainboard through the plurality of pillars and having a gap with the mainboard; and
an imaging module comprising a photosensitive sensor and a lens assembly, wherein the photosensitive sensor is integrated on the sub-circuit board, the lens assembly is connected to one side of the sub-circuit board facing away from the mainboard and disposed opposite to the photosensitive sensor, a collecting end of the lens assembly facing away from the photosensitive sensor is exposed to the housing, and the lens assembly is used for focusing external light rays entering from the collecting end on the photosensitive sensor.

2. The photographic device according to claim 1, wherein the pillar comprises a first section and a second section adjoining each other, one end of the first section facing away from the second section is fixed to the mainboard, and a cross-sectional area of the first section is larger than a cross-sectional area of the second section.

3. The photographic device according to claim 1, wherein the sub-circuit board is sleeved on the second section and abuts against an end of the first section, so that the first section partitions the sub-circuit board from the mainboard; and
a resilient member is sleeved on a part on the second section which is located on one side of the sub-circuit board facing away from the mainboard, the second section is provided with a threaded portion, a threaded fastener is connected to the threaded portion, and the threaded fastener is used for compressing the resilient member and crimping the sub-circuit board on the first section through the resilient member.

4. The photographic device according to claim 3, wherein the lens assembly comprises a lens and an encapsulation shell, the lens is at least partially disposed in the encapsulation shell, the encapsulation shell is fixedly connected to the sub-circuit board, and the collecting end is one end of the lens facing away from the photosensitive sensor;
the housing is provided with a window, the collecting end is exposed to the window, and at least part of an inner edge of the window is in contact with at least part of an outer edge of the collecting end; and
the resilient member is used for releasing a bending moment or torque on the sub-circuit board.

5. The photographic device according to claim 1, wherein one end of the pillar is fixed to the mainboard, and a resilient member is sleeved on the pillar; and
the sub-circuit board is sleeved on the pillar, so that the resilient member abuts between the sub-circuit board and the mainboard, and the gap is formed between the sub-circuit board and the mainboard.

6. The photographic device according to claim 5, the pillar is provided with a threaded portion, a threaded fastener is connected to the threaded portion, and the threaded fastener is used for applying a force to one surface of the sub-circuit board facing away from the mainboard, so as to compress the resilient member, so that the sub-circuit board is crimped and fixed between the threaded fastener and the resilient member.

7. The photographic device according to claim 5, wherein the lens assembly comprises a lens and an encapsulation shell, the lens is at least partially disposed in the encapsulation shell, the encapsulation shell is fixedly connected to the sub-circuit board, and the collecting end is one end of the lens facing away from the photosensitive sensor;
the housing is provided with a window, the collecting end is exposed to the window, and at least part of an inner edge of the window is in contact with at least part of an outer edge of the collecting end; and
the resilient member is used for releasing a bending moment or torque on the sub-circuit board.

8. The photographic device according to claim 1, wherein the housing comprises a first housing and a second housing which are buckled and connected with each other, the mainboard is disposed inside the first housing, the sub-circuit board is disposed on one side of the mainboard facing the second housing, and the collecting end is exposed to the second housing.

9. The photographic device according to claim 8, wherein one side of the mainboard facing away from the sub-circuit board is provided with a main control unit and a storage unit, an inner wall of the first housing is convexly formed with a heat conducting platform respectively in contact with the main control unit and the storage unit, and the heat conducting platform is used for transferring heat of the main control unit and the storage unit to the first housing, so as to dissipate the heat by the first housing.

10. The photographic device according to claim 1, wherein the lens assembly comprises a fisheye lens, the photosensitive sensor has a square shape, and an imaging circle diameter of the fisheye lens is less than or equal to a side length of the photosensitive sensor.

11. The photographic device according to claim 10, wherein the housing has a light-transmitting area located at the periphery of the lens assembly, a plurality of illumination modules are disposed inside the light-transmitting area, and the plurality of illumination modules are uniformly distributed at intervals along the periphery of the imaging module; and
optical axes of the plurality of illumination modules intersect with an optical axis of the fisheye lens, and an intersection point formed by intersection is located behind the fisheye lens.

12. The photographic device according to claim 1, further comprising a bracket, wherein the bracket is connected to the housing, and the bracket is used for being fixedly connected to an external bearing member to fix the photographic device to the external bearing member.

13. The photographic device according to claim 12, wherein the other side on the housing facing away from one side for the lens assembly to be exposed is provided with a first clamping portion, and the bracket is provided with a second clamping portion.

14. The photographic device according to claim 13, wherein the second clamping portion forms clamping connection with the first clamping portion when the bracket rotates along a first rotation direction relative to the housing, so that the bracket and the housing are fixed to each other.

15. The photographic device according to claim 13, wherein the second clamping portion is separated from the first clamping portion when the bracket rotates along a second rotation direction relative to the housing, so that the bracket and the housing are separated from each other, wherein the second rotation direction is opposite to the first rotation direction.

16. The photographic device according to claim 13, wherein one side on the housing on which the first clamping portion is located is further provided with a limiting portion, and the bracket is provided with a locking portion.

17. The photographic device according to claim 16, wherein the locking portion is in clamping fit with the limiting portion after the first clamping portion forms clamping connection with the second clamping portion, so as to limit the rotation of the bracket along the second rotation direction relative to the housing.

18. The photographic device according to claim 16, wherein the locking portion is separated from the limiting portion when being subjected to an acting force towards a direction facing away from the housing, so as to relieve the limitation on the rotation of the bracket along the second rotation direction relative to the housing.
